(19) United States
(12) Patent Application Publication
(10) Pub. No.: US 2012/0261348 A1
(43) Pub. Date: Oct. 18, 2012

(54) APPARATUS FOR EXTRACTING BIOMATERIAL AND METHOD OF EXTRACTING BIOMATERIAL USING THE APPARATUS

(75) Inventors: Kyeongwan Roh, Changwon-city (KR); Sung-hun Lee, Changwon-city (KR)

(73) Assignee: SAMSUNG TECHWIN CO., LTD., Changwon-city (KR)

(21) Appl. No.: 13/405,400

(22) Filed: Feb. 27, 2012

(30) Foreign Application Priority Data
Apr. 13, 2011 (KR) 10-2011-0034418

(51) Int. Cl. B03C 1/02

(52) U.S. Cl. 210/695; 210/222

(57) ABSTRACT

An apparatus for extracting biomaterials includes: a container body; a capturing unit which is formed on a side of the container body to receive a sample mixed with magnetic beads and flow the received sample mixed with the magnetic beads into the container body; and a magnet disposed outside the capturing unit which captures at an inner wall of the capturing unit the magnetic beads from the sample mixed with the magnetic beads while the sample mixed with the magnetic beads is flown into the container body.

### CROSS-REFERENCE TO RELATED APPLICATIONS

This application claims priority from Korean Patent Application No. 10-2011-0034418 filed on Apr. 19, 2011 in the Korean Intellectual Property Office, the disclosures of which are incorporated herein in their entirety by reference.

### BACKGROUND

1. Field

Apparatuses consistent with exemplary embodiments relate to extracting biomaterials, and more particularly, to containers for extracting biomaterials and methods of extracting biomaterials using the containers, by which biomaterials, such as nucleic acids, may be extracted using magnetic beads.

2. Description of the Related Art

A process of extracting proteins or nucleic acids from a variety of clinical samples in the bio-medical field is very important for molecular diagnostics. For example, in extracting nucleic acids, purity, yield rate, and reliability of the nucleic acids, removal of obstructive factors in the molecular diagnosis, sensitivity of the molecular diagnosis, and cross contamination between samples need to be considered to optimize the process.

There are various methods of extracting biomaterials, such as physical, chemical, or biochemical methods, for example. Furthermore, recently, a method of extracting biomaterials using magnetic beads or silica matrices has been introduced.

In order to extract nucleic acids from a sample in a liquid form that includes biomaterials such as nucleic acids, a method including combining magnetic beads with the nucleic acids, using a magnet to separate the magnetic beads may be used. The method works by adding the magnetic beads to the sample that includes nucleic acids, agitating the sample until the magnetic beads are combined with the nucleic acids, and using a magnet to separate the magnetic beads.

### SUMMARY

One or more exemplary embodiments provide apparatuses for extracting biomaterials which may efficiently retrieve magnetic beads by reforming the container which contains a sample with the magnetic beads, and methods of extracting biomaterials using the apparatuses.

Additional aspects will be set forth in part in the description which follows and, in part, will be apparent from the description, or may be learned by practice of one or more exemplary embodiments.

According to an aspect of an exemplary embodiment, an apparatus for extracting biomaterials includes: a container body; a capturing unit which is formed on a side of the container body to receive a sample mixed with magnetic beads and flow the received sample mixed with the magnetic beads into the container body; and a magnet disposed outside the capturing unit which captures at an inner wall of the capturing unit the magnetic beads from the sample mixed with the magnetic beads while the sample mixed with the magnetic beads is flown into the container body.

The magnet may be a permanent magnet, which is disposed to be removable from around the capturing unit.

The magnet may be an electromagnet, which is able to capture the magnetic beads when a current is applied thereto, and loses its magnetic force when the current is not applied thereto.

The magnet may be disposed to contact the capturing unit.

The capturing unit may have a type of tube narrower than the container body.

The apparatus may further include a connection part between the capturing unit and the container body.

The sample mixed with the magnetic beads may flow on the wall of the capturing unit.

The apparatus may further include an inflow part in which the sample mixed with the magnetic beads from the outside flows on the wall of the inflow part.

The capturing unit may be disposed between the inflow part and the container body, the capturing unit having a smaller inclination than the inflow part.

According to an aspect of another exemplary embodiment, a method of extracting biomaterials includes: mixing a sample comprising an object material with magnetic beads, to combine the magnetic beads and the object material; flowing the sample mixed with the magnetic beads into a container body of a container through a capturing unit of the container around which a magnet is disposed; capturing the magnetic beads which are combined with the object material, at the capturing unit using the magnet, to separate the magnetic beads from the sample; removing extraneous substances around the object material which is combined with the magnetic beads; and extracting the object material by separating the object material from the magnetic beads.

The method may further include injecting the magnetic beads into the sample by using an injection tip without having the injection tip touch the sample.

The mixing the sample with the magnetic beads may be performed using a mixing tip to inhale and discharge the sample into which the magnetic beads are injected.

The method may further include: allowing the sample from which has been separated from the magnetic beads combined with the object material to be contained in the container body; and removing the sample by inhaling the sample with the mixing tip.

The method may further include: injecting a washing buffer to the container body with the injection tip without having the injection tip touch the container body; inhaling the washing buffer with the mixing tip from the container body; and allowing the magnetic beads which are combined with the object material to be contained in the container body by using the mixing tip to flow the washing buffer down to the capturing unit where the magnetic beads have been captured.

The method may further include: injecting an elution buffer into the container body with the injection tip without having the injection tip touch the container body; inhaling the elution buffer with the mixing tip from the container body; and allowing the magnetic beads that are combined with the object material to be contained in the container body by using the mixing tip to flow the elution buffer down to the capturing unit where the magnetic beads have been captured.

The method may further include: mixing the object material with the magnetic beads by using the mixing tip to inhale and discharge the elution buffer which is mixed with the magnetic beads; flowing the elution buffer flows through the capturing unit where the magnet is disposed, using the magnet to capture the magnetic beads; allowing the elution buffer to be separated from the magnetic beads, mixed with the object material, and contained in the container body; and using the mixing tip to inhale the elution buffer mixed with the object material to be removed from the container body.

In the method, a same injection tip, a same mixing tip, and a same container may be used.

The removing the extraneous substances around the object material may be performed one or more times.

The capturing unit may be disposed outside of the container body and connected to the container body through a connection part which slows down the speed of the flowing the sample mixed with the magnetic beads.

### BRIEF DESCRIPTION OF THE DRAWINGS

These and/or other aspects will become apparent and more readily appreciated from the following description of the exemplary embodiments, taken in conjunction with the accompanying drawings, in which:

FIG. 1 is a schematic diagram of a container for extracting biomaterials, according to an exemplary embodiment;

FIG. 2 is a schematic diagram of a container for extracting biomaterials, according to another exemplary embodiment;

FIGS. 3A-3C schematically illustrate a process of mixing magnetic beads with a sample that contains biomaterials in the method of extracting biomaterials, according to an exemplary embodiment;

FIG. 4A-4C schematically illustrate a mixing process in the method of extracting biomaterials, according to an exemplary embodiment;

FIGS. 5A and 5B schematically illustrate a process of separating magnetic beads from a sample in the method of extracting biomaterials, according to an exemplary embodiment;

FIGS. 6A-6C schematically illustrate a process of removing or extracting a sample from which magnetic beads has been separated in the method of extracting biomaterials, according to an exemplary embodiment;

FIGS. 7A-7D schematically illustrate a process of washing magnetic beads to which biomaterials are attached in the method of extracting biomaterials, according to an exemplary embodiment; and

FIGS. 8A-8D schematically illustrate a process of separating magnetic beads so as to extract biomaterials in the method of extracting biomaterials, according to an exemplary embodiment.

### DETAILED DESCRIPTION OF EXEMPLARY EMBODIMENTS

Hereinafter, exemplary embodiments are illustrated in referent to the accompanying drawings, in which like reference numerals may refer to like elements throughout. In this regard, the exemplary embodiments may have different forms and should not be construed as being limited to the descriptions set forth herein. Accordingly, the exemplary embodiments are merely described below, by referring to the figures, to explain aspects of the present description. Element sizes and thicknesses are exaggerated for clarity.

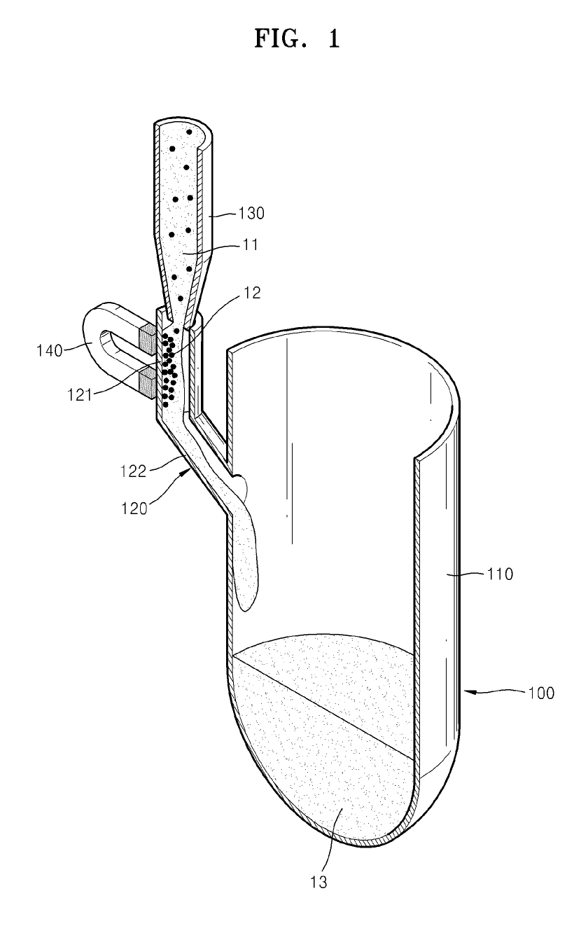

FIG. 1 is a schematic cross-sectional diagram of a container 100 for extracting biomaterials, according to an exemplary embodiment.

Referring FIG. 1, the container 100 may include a container body 110 and a capturing unit 120. The capturing unit 120 may include a capturing part 121 and a connection part 122.

The container body 110 may contain a sample 13. A sample 11 mixed with magnetic beads 12 flows through the capturing part 121 connected to the container body 110, and a magnet 140 may be disposed around the capturing part 121 to capture the magnetic beads 12 from the sample 11 mixed with the magnetic beads 12. The magnet 140 may be any type of magnet that is capable of generating magnetic force, such as a permanent magnet or an electromagnet. For example, in the case of using an electromagnet, it is easy to determine whether to capture the magnetic beads 12 or let the magnetic beads 12 flow into the container body 110 by controlling a current that is applied to the electromagnet.

The container 100 may efficiently retrieve the magnetic beads 12 by reforming the shape of the container 100 that contains the sample 11 mixed with the magnetic beads 12.

In a related art container, while a mixed sample in a liquid form is contained in a container body, a magnet may be used to capture and retrieve magnetic beads from the mixed sample. The magnet may be disposed below the bottom or on a side of the container body to capture the magnetic beads. The related art container may take more time to capture the magnetic beads when the magnet is disposed below the bottom of the container body to capture the magnetic beads than when the magnet is disposed on a side of the container body.

In this case, if the amount of the mixed sample in the liquid form is large or the container body has a large volume, magnetic force becomes weaker for spots in the container body which are away from the magnet 140, thus reducing the efficiency in capturing the magnetic beads.

In another related art container, a magnet may be positioned around a head part of a liquid sample dispenser to which a tip for supplying a mixed sample is attached, to capture the magnetic beads. In this case, the magnet may capture the magnetic beads on the side of a narrow path of the tip, so a magnet generating relatively weak magnetic force may be employed and capturing efficiency may increase. However, the head part around which the magnet is installed may weigh heavily and narrowing the distance between adjacent tips may hardly be achieved.

In the container 100 for extracting biomaterials, according to the present embodiment, while the sample 11 mixed with the magnetic beads 12 flows through the capturing part 121, the magnet 140 positioned around the capturing part 121 may capture the magnetic beads 12. Accordingly, the magnetic beads 12 may be captured using a magnet generating relatively weak magnetic force without disposing a separate device around the tip for capturing the magnetic beads 12, thus increasing capturing efficiency.

Here, the magnet 140 may be disposed to contact a surface of the capturing part 121. This may intensify the magnetic force reaching the sample 11 mixed with the magnetic beads 12, which flows through the capturing part 121, and a range covered by the magnetic force may also be enlarged. Therefore, efficiency in capturing the magnetic beads 12 by the magnet 140 may increase.

Furthermore, the magnet 140 may also be disposed to be removable from around the capturing part 121. This may efficiently utilize equipment to be used in a process of extracting biomaterials using the container 100. For example, in the case of using a permanent magnet as the magnet 140, removing or approaching the magnet 140 from or to the capturing part 121 may determine whether to capture the magnetic beads 12 or not. On the other hand, in the case of using an electromagnet instead of the permanent magnet as the magnet 140, controlling a current to be applied to a coil of the electromagnet may determine whether to capture the magnetic beads 12 or not.

The sample 11 mixed with the magnetic beads 12 may be contained in a mixing tip 130, and then, be injected through an injection gate at an end of the mixing tip 130 into the capturing part 121. The sample 11 mixed with the magnetic beads 12 may flow on an inner wall of the capturing part 121 when supplied into the capturing part 121. Therefore, the magnet beads 12 included in the sample 11 may be easily captured and attached to the inner wall of the capturing part 121.

Here, the sample 11 mixed with the magnetic beads 12 that is contained in the mixing tip 130 may be injected into the capturing part 121 by a predetermined pressure applied through the mixing tip 130. In this way, the sample 11 mixed with the magnetic beads 12 may be smoothly supplied into the capturing part 121.

The capturing part 121 may have a tubular shape which is narrower than the container body 110. The capturing part 121 of the tubular shape may form a narrow flow path inside the capturing part 121. That is to say, the narrow flow path is formed in a space of the capturing part 121 in which the sample 11 mixed with the magnetic beads 12 is contained, and the magnet 140 may capture the magnetic beads 12 in the capturing part 121 by separating the magnetic beads 12 from the sample 11 that flows through the narrow flow path.

From the sample 11 mixed with the magnetic beads 12 flowing through the narrow flow path, the magnetic beads 12 may be captured around the magnet 140 while the sample 13, resulting from separating the magnetic beads 12 from the sample 11, may flow down into the container body 110. Here, some of the magnetic beads 12 that have not been captured by the magnet 140 may be contained in the container body 110 with the sample 13.

As the sample 11 mixed with the magnetic beads 12 flows on the inner wall of the narrow flow path, the speed of the sample 11 flowing through the narrow flow path may become slow, which may help the magnetic beads 12 included in the sample 11 to be easily captured and attached to the inner wall of the narrow flow path of the capturing unit 121.

The magnet 140 may be disposed to surround at least a part of the capturing part 121. For example, if the capturing part 121 has a tubular shape and forms a narrow flow path therein, the magnet 140 may be disposed to surround the capturing part 121 of the tubular shape. In this case, an area of the capturing unit part surrounded by the magnet 140 increases, and thus, the efficiency in capturing the magnetic beads 12 in the capturing unit part may also increase.

Furthermore, in the case of the capturing part 121 being in the shape of a narrow tube, the connection part 122 may be connected between the capturing part 121 and the container body 110. That is, while the sample 11 mixed with the magnetic beads 12 flows through the capturing part 121, the magnetic beads 12 are captured by the magnet 140, and thus, attached to the inner wall of the capturing part 121, and the sample 13 resulting from capturing the magnetic beads 12 from the sample 11 flows through the connection part 122, and ends up being contained in the container body 110.

Here, the capturing part 121 and the connection part 122 together form the capturing unit 120, which may be connected to an upper part of an outer side wall of the container body 110. The sample 11 mixed with the magnetic beads 12 injected from the mixing tip 130 through the injection gate at one end of the capturing unit 120 may flow through the capturing unit 120 into the container body 110. Therefore, while the sample 11 mixed with the magnetic beads 12 flows through the capturing unit 120, sufficient time for capturing the magnetic beads 12 may be ensured.

The capturing unit 120 is exposed to the outside at one end while being connected to the container body 110 at the other end. The capturing unit 120 may have a narrower width than the container body 110 and may have a magnet disposed around the capturing unit 120. Thus, the capturing unit 120 may form a narrow flow path through which the sample 11 mixed with the magnetic beads 12 flows and in which the magnetic beads 12 may be captured. The narrow flow path may allow the sample 11 mixed with the magnetic beads 12 to slowly flow through the capturing unit 120, thus the sample 13 resulting from capturing the magnetic beads 12 from the sample 11 mixed with the magnetic beads 12 is contained in the container body 110.

The capturing unit 120 may include the capturing part 121 and the connection part 122. The capturing part 121 may allow the sample 11 mixed with the magnetic beads 12 to be injected therein from an end of the capturing unit 121, and may allow the magnetic beads 12 to be captured from the sample 11. The connection part 122 may be connected between the capturing part 121 and the container body 110.

In the case the container body 110 is disposed vertically, the capturing unit 121 may be vertically disposed in parallel with the container body 110 substantially, and the connection part 122 may be connected between the capturing unit 121 and the container body 110 with a predetermined inclination. Here, a space for the magnet 140 to be disposed may be secured, such that the magnet 140 may be disposed to contact or to be at a predetermined distance from the capturing part 121 disposed vertically.

In the exemplary embodiment illustrated in FIG. 1, a part being connected in parallel with the container body 110 corresponds to the capturing part 121 around which the magnet 140 is disposed to capture the magnetic beads 12. However, the inventive concept is not limited thereto, and the magnet 140 may surround the connection part 122 connected between the capturing part 121 and the container body 110 with a predetermined inclination.

In the latter case, the magnetic beads 12 may be captured somewhere in the inclination part of the connection part 122 where the flowing speed of the sample 11 mixed with the magnetic beads 12 becomes slow. Thus, the magnet 140 may capture the magnetic beads 12 more easily.

In other words, the capturing part 121 of FIG. 1 may correspond to an inflow part into which the sample 11 mixed with the magnetic beads 12 flows from the outside on the inner wall thereof, and the connection part 122 of FIG. 1 may correspond to a capturing part in which the magnetic beads 12 are captured. Here, the connection part 122 may be disposed to have less inclination than the inflow part.

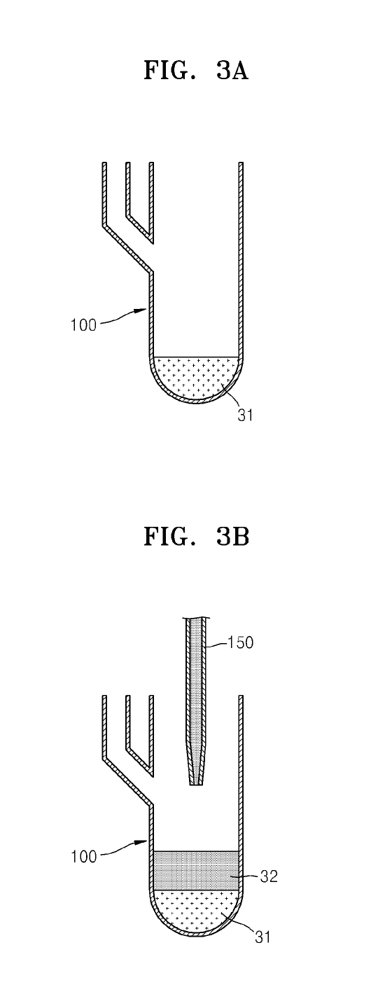

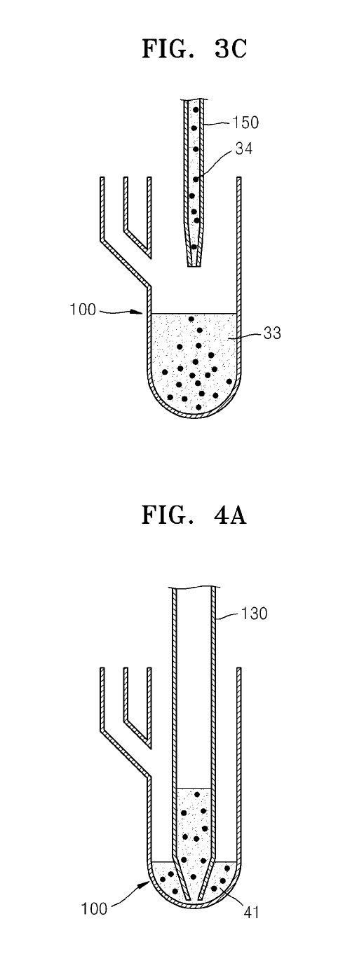

The container 100 for extracting biomaterials may be used to extract biomaterials according to methods of extracting biomaterials illustrated in FIGS. 3A to 8D, according to exemplary embodiments.

Using the container 100 for extracting biomaterials according to an exemplary embodiment may simplify a method of extracting biomaterials, and may reduce waste of an injection tip 150 shown in FIGS. 3A to 3C, the mixing tip 130, and/or the container 100. For example, the entire process of extracting biomaterials using the container 100 may be performed, thereby only using one injection tip 150, one mixing tip 130, and one container 100.

When the container 100 for extracting biomaterials is used to capture magnetic beads, the injection tip 150 may inject the magnetic beads 34 into a mixed sample 31 while being handled not to touch samples 31 and 33, as shown in FIGS. 3A to 3C. In this way, the injection tip 150 is not contaminated by the samples 31 and 33, so the same injection tip 150 may be used in subsequent processes without need for replacement.

Furthermore, the same mixing tip 130 may be used in all processes. This may lead to reduction in expendable supplies.

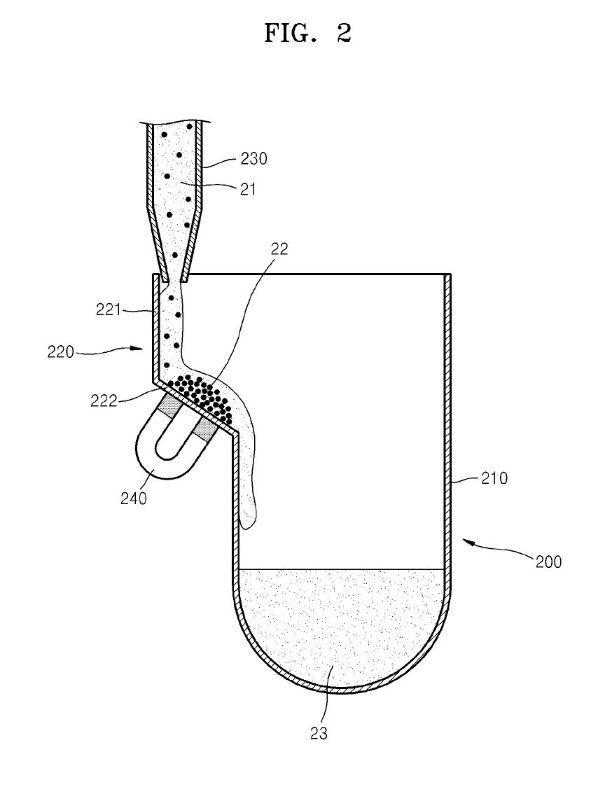

FIG. 2 schematically shows a cross-sectional diagram of a container 200 for extracting biomaterials, according to another exemplary embodiment. In the embodiment of FIG. 2, magnetic beads 22 are captured in an upper capturing part 220 instead of the capturing unit 120 as shown in FIG. 1. Description about the same parts as those of FIG. 1 will not be described in detail.

Referring to FIG. 2, a container 200 for extracting biomaterials may include a container body 210 and the upper capturing part 220. The container body 210 may contain a sample 23. While a sample 21 mixed with the magnetic beads 22 flows through the upper capturing part 220, the magnetic beads 22 may be captured by a magnet 240.

The sample 21 mixed with the magnetic beads 22 is flowing alongside an inner wall of the upper capturing part 220, which slows down a flowing speed of the sample 21 mixed with the magnetic beads 22 and makes the magnet 240 capture the magnetic beads 22 more easily.

The upper capturing unit 220 may include an inflow part 221 and a capture part 222. The inflow part 221 corresponds to an injection part of the container 200 allowing the sample 21 mixed with the magnetic beads 22 to flow in alongside the inner wall of the inflow part 221. The sample 21 mixed with the magnetic beads 22 which are introduced into the inflow part 221 may flow along the capture part 222 and may be contained in the container body 210.

The sample 21 mixed with the magnetic beads 22 may be supplied into the inflow part 221 via a mixing tip 230. The capture part 222 may be disposed between the inflow part 221 and the container body 210. The capture part 222 may be formed to have less inclination than the inflow part 221, which slows down the flowing speed of the mixed sample 21, and thus, makes the magnetic beads 22 captured there easily.

In the embodiment shown in FIG. 2, an inclined part connected to the container body 210 and surrounded by the magnet 240 for capturing the magnetic beads 22 forms the capture part 222. However, the inventive concept is not limited to this, but may also have a different exemplary embodiment as shown in reference to FIG. 1.

In the case where the container body 210 is oriented vertically, the inflow part 221 is substantially parallel with the container body 210. Here, the capture part 222 may be a connection part between the inflow part 221 and the container body 210. In this case, a space for the magnet 240 to be disposed may be secured, such that the magnet 240 may be disposed to contact or to be at a predetermined distance from the capture part disposed vertically.

FIGS. 3A to FIG. 8D schematically illustrate a method of extracting biomaterials according to an exemplary embodiment. The method is implemented using the container 100 or 200 for extracting biomaterials as shown in FIG. 1 and/or FIG. 2, so the description about similar functions with respect to the container 100 or 200 will be omitted.

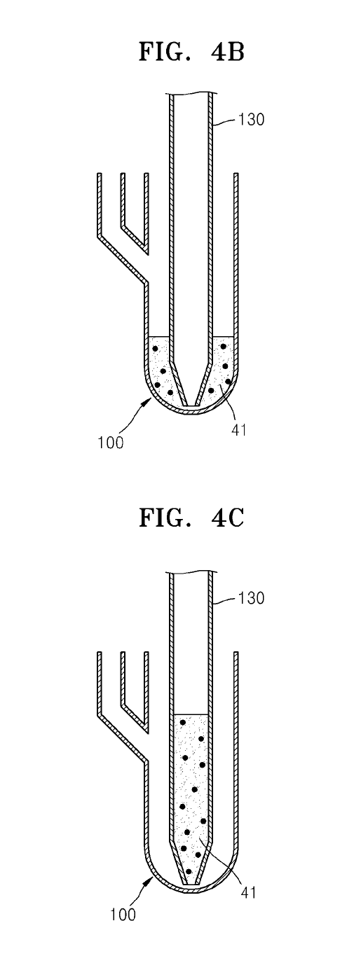

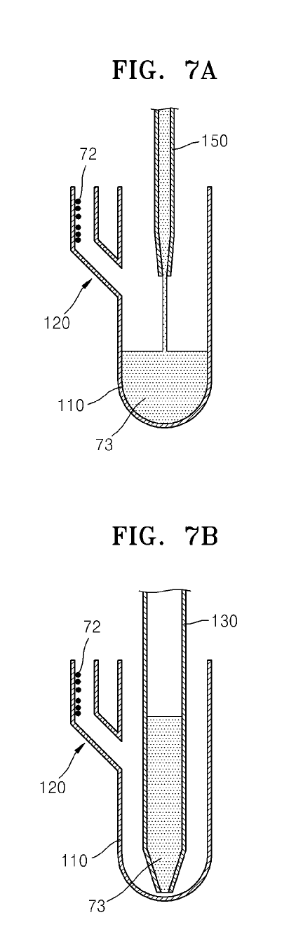

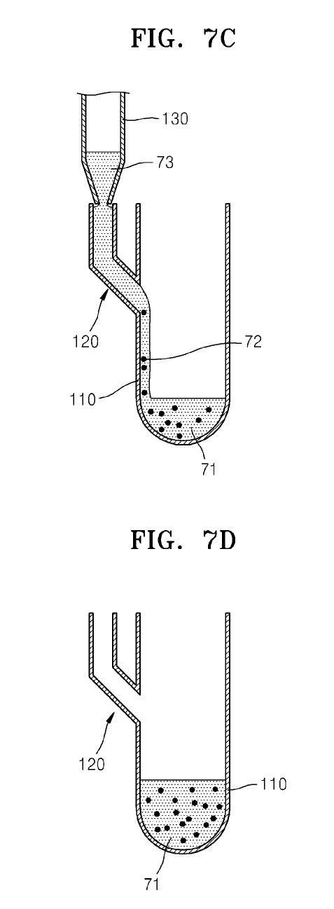

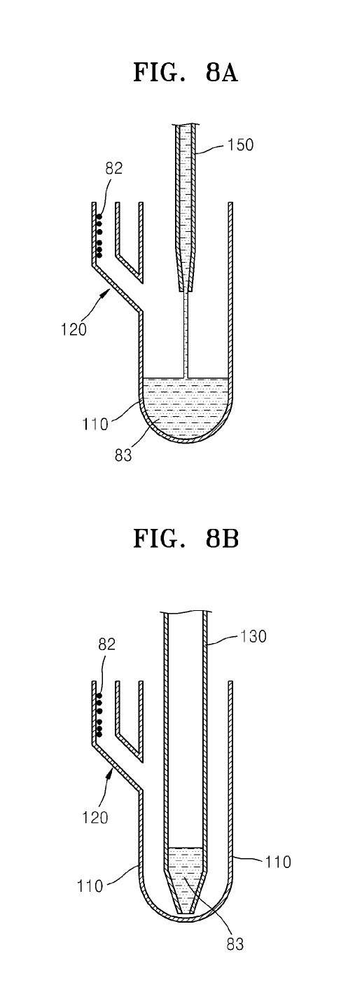

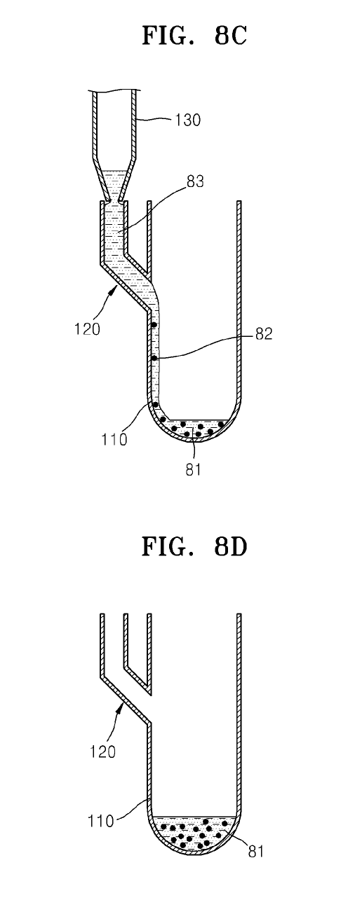

Referring to FIGS. 3A to 8D, the method of extracting biomaterials may include a process of combining magnetic beads as shown in FIGS. 3A to 3C, a process of separating the magnetic beads as shown in FIGS. 4A to 6C, a washing process as shown in FIGS. 7A to 7D, and an elution process as shown in FIGS. 8A to 8D.

In the process of combining magnetic beads shown in FIGS. 3A to 3D, magnetic beads 34 are mixed with a sample 33 that includes an object material, thus combining the magnetic beads 24 with the object material. In the process of separating the magnetic beads 24 shown in FIGS. 4A to 6C, while a sample 33, 41 or 51 including the magnetic beads 34, 52 or 62 flows through an area around which the magnet 140 is disposed, the magnet 140 may capture the magnetic beads 34, 52 or 62, thus to separate the magnetic beads 34, 52 or 62 from the sample 33, 53 or 63.

In the washing process shown in FIGS. 7A to 7D, extraneous substances around the object material that is combined with the magnetic beads 72 may be removed. In the elution process shown in FIGS. 8A to 8D, the object material may be separated from the magnetic beads 82 to extract the object material.

The method of extracting biomaterials according to an embodiment, as shown in FIGS. 3 to 8, may retrieve the magnetic beads 82 efficiently by using a shape-reformed container to separate the magnetic beads 82 and then extract biomaterials.

In addition, the method of extracting biomaterials as shown in FIGS. 3 to 8 may simplify the overall process and reduce waste of the injection tip 150, the mixing tip 130, and/or the container 100.

While the sample 33, 41 or 51 including the magnetic beads 34, 52 or 62 flows through an area that the magnet 140 is disposed around, the magnet 140 may capture the magnetic beads 34, 52 or 62 that is combined with the object material to separate the magnetic beads 34, 52 or 62 from a sample 33, 53 or 63.

The magnetic beads 34, 52 or 62 may be easily captured and attached to the inner wall of the capturing unit 120. Here, the sample 31, 41 or 51 mixed with the magnetic beads 34, 52 or 62 may be injected into the capturing unit 120 by a predetermined pressure applied through the mixing tip 130. That way, the sample 31, 41 or 51 mixed with the magnetic beads 34, 52 or 62 may be smoothly injected into the capturing unit 120.

In the process of combining the magnetic beads 34 shown in FIGS. 3A to 3C, the magnetic beads 34 may be injected by the injection tip 150 into the sample 31, while the injection tip 150 is handled not to touch the sample 31. In other processes, the injection tip 150 is handled not to touch a sample. As such, the injection tip 150 is not contaminated by the sample 31 or the sample 33 mixed with the magnetic beads 34, so it may be used in other processes without need for replacement.

In addition, the mixing tip 130 may also be used in subsequent processes. By using a single mixing tip 130 in all processes, the waste of expendable supplies may be reduced. Here, the mixing tip 130 is larger in size than the injection tip 150, thus having larger capacity.

In the process of combining magnetic beads shown in FIGS. 3A to, firstly, the sample 31 that is an object sample, for example, blood 31 is contained in the container 100 (FIG. 3A). Then, using the injection tip 150, a lysis buffer 32 is injected into the container 100 (FIG. 3B). The lysis buffer 32 may include lysozyme and/or chloroform. By the injection of the lysis buffer 32, cell walls or cell membranes of the blood 31 may be destroyed, and thus, cell contents may be released.

Then, protease (not shown), the magnetic beads 34, and/or a bead binder (not shown) are injected into the container 100 (FIG. 3C). The protease, the magnetic beads 34, and/or the bead binder may each be injected into the container 100 using the injection tip 150.

Because the injection tip 150 is not contaminated by the sample 31 or 33, a single injection tip 150 may be used for all processes without replacement.

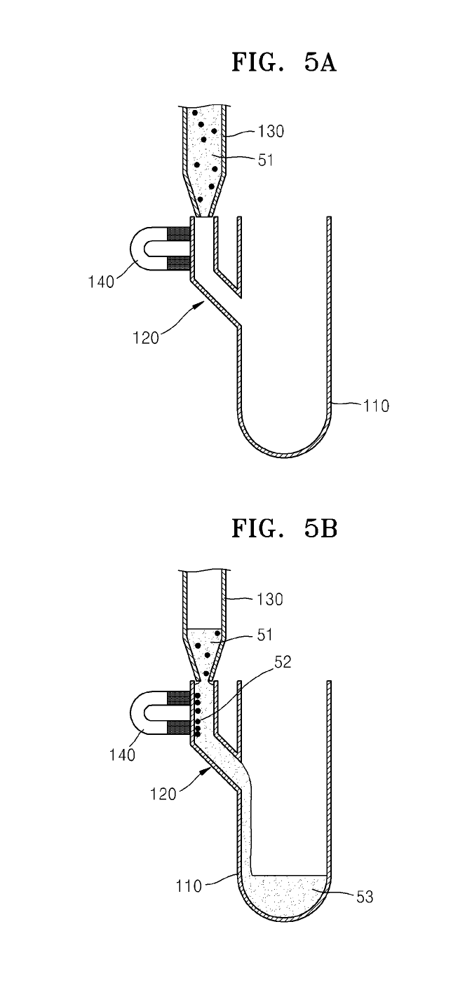

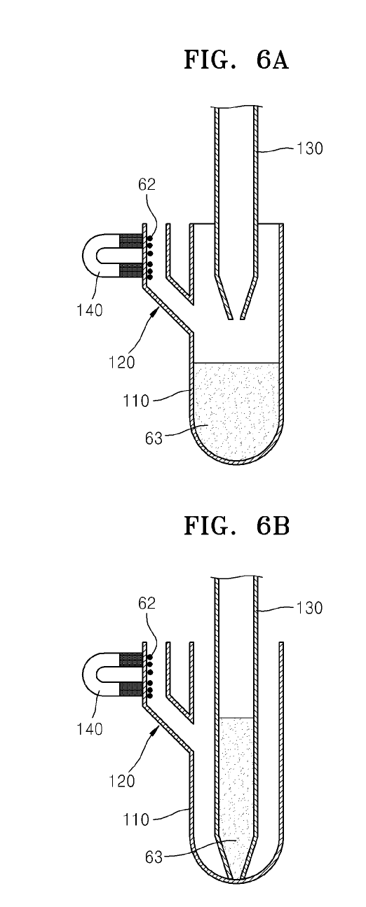

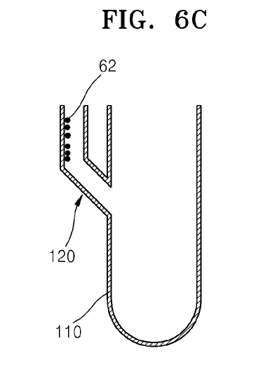

The process of separating the magnetic beads 34, as shown in FIGS. 4A to 6C, may include a mixing process shown in FIGS. 4A to 4C, a separation process shown in FIGS. 5A and 5B, and a buffer removing process shown in FIGS. 6A to 6C.

In the mixing process of FIG. 4A to 4C, the magnetic beads 34 may be mixed with the sample 41 by the mixing tip 130 by inhaling and discharging the sample 41 mixed with the magnetic beads 34. In the separation process of FIGS. 5A and 5B, while the sample 51 mixed with the magnetic beads 52 is passing through the capturing unit 120, the magnet 140 may capture and separate the magnetic beads 52 from the sample 53 (FIG. 5A). The sample 53 resulting from separating the magnetic beads 52 that are combined with an object material from the sample 51 may be contained in the container body 110 (FIG. 5B).

In the buffer removing process shown in FIGS. 6A to 6C, the mixing tip 130 may inhale the sample 63 separated from magnetic beads 62 to remove the sample 63 out of the container body 110.

The washing process shown in FIGS. 7A to 7C may include a process of injecting a washing buffer (FIG. 7A), a process of inhaling the washing buffer (FIG. 7B), and another process of injecting the washing buffer (FIGS. 7C and 7D). The washing process may begin with magnetic beads 72 being captured and attached to the capturing unit 120.

The washing process may be performed one or more times. By repeatedly performing the washing process several times, extraneous substances around an object material combined with magnetic beads 72 may be cleanly removed. The number of times of performing the washing process is freely determined depending on how long it takes and/or to what extent it is required.

In the process of injecting a washing buffer, while the injection tip 150 is handled not to touch the container body 110, the injection tip 150 may inject a washing buffer 73 into the container body 110 (FIG. 7A). In the process of inhaling the washing buffer, the mixing tip 130 may inhale the washing buffer 73 out of the container body 110 (FIG. 7B). In another process of injecting the washing buffer, the mixing tip 130 may flow the washing buffer 73 down to an area where magnetic beads 72 have been captured, and thus, a buffer 71 including the magnetic beads 72 combined with the object material may be contained in the container body 110 (FIGS. 7C and 7D).

After the washing process of FIGS. 7A to 7D is completed, the process of separating magnetic beads shown in FIGS. 4A to 6C may be performed.

The elution process shown in FIGS. 8A to 8D may include a process of injecting an elution buffer (FIG. 8A), a process of inhaling the elution buffer (FIG. 8B), and another process of injecting the elution buffer (FIGS. 8C and 8D). The elution process of FIG. 8 may begin with the magnetic beads 82 being captured and attached to the capturing unit 120.

In the process of injecting an elution buffer, while the injection tip 150 is handled not to touch the container body 110, the injection tip 150 may inject an elution buffer 83 into the container body 110 (FIG. 8A).

In the process of inhaling the elution buffer, the mixing tip 130 may inhale the elution buffer 83 from the container body 110 (FIG. 8B). In another process of injecting the elution buffer, the mixing tip 130 may flow the elution buffer 83 down to an area where magnetic beads 82 have been captured, and thus, a buffer 81 including the magnetic beads 82 combined with an object material may be contained in the container body 110 (FIG. 8C and 8D).

After the elution process is completed, the process of separating magnetic beads shown in FIGS. 4A to 6C may be performed. The process of separating magnetic beads may include the mixing process shown in FIGS. 4A to 4C, the separating process shown in FIGS. 5A and 5B, and the buffer extracting process shown in FIGS. 6A to 6C.

In the mixing process of FIGS. 4A to 4C, the mixing tip 130 may inhale and discharge the elution buffer 41 mixed with magnetic beads to mix an object material with the magnetic beads. In the separating process of FIG. 5A and 5B, while the elution buffer 51 flows through the area that the magnet 140 is disposed around, the magnet 140 may capture the magnetic beads 52 to separate the magnetic beads 52 from an elution solution 53.

In the buffer extracting process shown in FIGS. 6A to 6C, the magnetic beads 62 are separated, the elution buffer 63 mixed with an object material is contained in the container body 110, and the mixing tip 130 may inhale the elution buffer 63 to be removed from the container body 110.

Carrying out the method of extracting biomaterials according to the above exemplary embodiment to extract biomaterials, as shown in FIGS. 3A to 8D, may simplify the entire processes, and reduce the waste of the injection tip 150, mixing tip 130, and/or container 100 for use in the processes.

For example, using only a single injection tip 150, a single mixing tip 130, and a single container, the entire processes of extracting biomaterials may be performed.

Although the method of extracting biomaterials shown in FIGS. 3A to 8D has mainly been described with respect to the container 100 for extracting biomaterials shown in FIG. 1, the invention is not limited thereto and may also be applied to the container 200 shown in FIG. 2.

As described above, according to the one or more of the above exemplary embodiments, magnetic beads may be efficiently retrieved by reforming a container for containing a sample mixed with magnetic beads. In addition, the biomaterial extracting process may be simplified, and the number of injection tips, mixing tips, and/or containers which are required in the process may be efficiently decreased.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. An apparatus for extracting biomaterials, the apparatus comprising:
a container body;
a capturing unit which is formed on a side of the container body to receive a sample mixed with magnetic beads and flow the received sample mixed with the magnetic beads into the container body; and
a magnet disposed outside the capturing unit, which captures at an inner wall of the capturing unit the magnetic beads from the sample mixed with the magnetic beads while the sample mixed with the magnetic beads is flown into the container body.

2. The apparatus of claim 1, wherein the magnet is a permanent magnet, which is disposed to be removable from around the capturing unit, or an electromagnet, which captures the magnetic beads when a current is applied thereto, and loses a magnetic force when the current is not applied thereto.

3. The apparatus of claim 1, wherein the magnet is disposed to contact the capturing unit.

4. The apparatus of claim 1, wherein the capturing unit is formed as a tube narrower than the container body.

5. The apparatus of claim 1, wherein the capturing unit comprises a capturing part and a connection part,
wherein, the magnet is disposed around the capturing part to capture, at the capturing part, the magnetic beads from the sample mixed with the magnetic beads while the sample mixed with the magnetic beads is flown into the container body, and
wherein the connection part is disposed between the capturing part and the container body, whereby the sample from which the magnetic beads are captured by the capturing part is flown into the container body through the connection part.

6. The apparatus of claim 5, wherein the capturing part comprises an inflow part which receives the sample mixed with the magnetic beads from an outside,
wherein the connection part is less inclined than the inflow part with respect to the container body.

7. The apparatus of claim 1, wherein the capturing unit comprises a capturing part and a connection part,
wherein the magnet is disposed around the connection part to capture, at the connection part, the magnetic beads from the sample mixed with the magnetic beads while the sample mixed with the magnetic beads is flown into the container body, and
wherein the connection part is disposed between the capturing part and the container body, whereby the sample from which the magnetic beads are captured by the capturing part is flown into the container body through the connection part.

8. The apparatus of claim 5, wherein the capturing part comprises an inflow part which receives the sample mixed with the magnetic beads from an outside,
wherein the connection part is less inclined than the inflow part with respect to the container body.

9. The apparatus of claim 1, wherein the connection unit comprise an inflow part which receives the sample mixed with the magnetic beads from an outside, and
wherein at least a portion of the capturing unit, which is connected to the container body, and through which the sample from which the magnetic beads are captured by the connection unit is flown into the container body, is less inclined than the inflow part with respect to the container body.

10. The apparatus of claim 1, wherein the capturing unit comprises:
an inflow part which receives the sample mixed with magnetic beads and flow the received sample mixed with the magnetic beads into the container body; and
a capture part which captures the magnetic beads from the sample mixed with the magnetic beads while the sample mixed with the magnetic beads is flown into the container body,
wherein the capture part is connected to the inflow part and bent from the inflow part to slow a flowing speed of the sample mixed with the magnetic beads at the capture part.

11. A method of extracting biomaterials, the method comprising, mixing a sample comprising an object material with magnetic beads, to combine the magnetic beads and the object material;
flowing the sample mixed with the magnetic beads into a container body of a container through a capturing unit of the container around which a magnet is disposed;
capturing the magnetic beads which are combined with the object material, at the capturing unit using the magnet, to separate the magnetic beads from the sample;
removing extraneous substances around the object material which is combined with the magnetic beads; and
extracting the object material by separating the object material from the magnetic beads.

12. The method of claim 11, further comprising injecting the magnetic beads into the sample by using an injection tip without having the injection tip touch the sample.

13. The method of claim 12, wherein the mixing the sample with the magnetic beads is performed using a mixing tip to inhale and discharge the sample into which the magnetic beads are injected.

14. The method of claim 13, further comprising:
allowing the sample from which has been separated from the magnetic beads combined with the object material to be contained in the container body; and
removing the sample by inhaling the sample with the mixing tip.

15. The method of claim 13, further comprising:
injecting a washing buffer to the container body with the injection tip without having the injection tip touch the container body;
inhaling the washing buffer with the mixing tip from the container body; and
allowing the magnetic beads which are combined with the object material to be contained in the container body by using the mixing tip to flow the washing buffer down to the capturing unit where the magnetic beads have been captured.

16. The method of claim 13, further comprising;
injecting an elution buffer into the container body with the injection tip without having the injection tip touch the container body;
inhaling the elution buffer with the mixing tip from the container body; and
allowing the magnetic beads that are combined with the object material to be contained in the container body by using the mixing tip to flow the elution buffer down to the capturing unit where the magnetic beads have been captured.

17. The method of claim 16, further comprising:
mixing the object material with the magnetic beads by using the mixing tip to inhale and discharge the elution buffer which is mixed with the magnetic beads;
flowing the elution buffer flows through the capturing unit where the magnet is disposed, using the magnet to capture the magnetic beads;
allowing the elution buffer to be separated from the magnetic beads, mixed with the object material, and contained in the container body; and
using the mixing tip to inhale the elution buffer mixed with the object material to be removed from the container body.

18. The method of claim 13, wherein a same injection tip, a same mixing tip, and a same container are used.

19. The method of claim 11, wherein the removing the extraneous substances around the object material is performed one or more times.

20. The method of claim 11, wherein the capturing unit is disposed outside of the container body and connected to the container body through a connection part which slows down the speed of the flowing the sample mixed with the magnetic beads.
